(19) United States
(12) Patent Application Publication
(10) Pub. No.: US 2024/0049720 A1
(43) Pub. Date: Feb. 15, 2024

(54) A SYNERGISTIC AGRICULTURAL COMPOSITION

(71) Applicants: UPL Corporation Limited, Port Louis (MU); UPL Europe LTD, Warrington (GB)

(72) Inventors: Marín Virgilio Valdés Caballero, Saltillo (MX); Susana Solis Gaona, Saltillo (MX); Paola Catalina Leija Martínez, Saltillo (MX); Mario Ramón Villareal Cárdenas, Saltillo (MX); María De Lourdes Delgado Hernandez, Saltillo (MX); Mauricio Alberto Vargas Martínez, Saltillo (MX)

(21) Appl. No.: 18/546,522

(22) PCT Filed: Feb. 16, 2022
(86) PCT No.: PCT/GB2022/050410

§ 371 Date: Aug. 15, 2023

(30) Foreign Application Priority Data
Feb. 17, 2021 (IN) 202121006674

(51) Int. Cl. A01N 59/20; A01N 43/16; A01N 25/04; A01P 3/00; A01P 1/00

(52) U.S. Cl. CPC A01N 59/20; A01N 43/16; A01N 25/04; A01P 3/00; A01P 1/00

(57) ABSTRACT

The present disclosure relates to agricultural combinations and compositions including kasugamycin or salt thereof and a copper salt, especially copper glycinate, that exhibits wide spectrum anti-microbial properties. Further aspects of the present disclosure relate to a synergistic anti-microbial agricultural formulation and a method of resistance management of phytopathogens and plant disease control.

### TECHNICAL FIELD

The present disclosure relates to agricultural compositions and combinations comprising kasugamycin and copper salt. Particularly, the present disclosure relates to an agricultural composition including kasugamycin or a salt thereof, and a copper salt that exhibits wide spectrum antimicrobial properties against phytopathogens. Further, aspects of the present disclosure relate to a synergistic antimicrobial agricultural formulation, a method of preparation thereof and a method of controlling phytopathogens.

### BACKGROUND

The background description includes information that may be useful in understanding the present disclosure. It is not an admission that any of the information provided herein is prior art or relevant to the present disclosure, or that any publication specifically or implicitly referenced is prior art.

Kasugamycin is an agricultural antibiotic bactericide that inhibits the proliferation of bacteria by affecting their ability to make new proteins, such as by targeting the ribosome. It exhibits both antibiotic and fungicidal properties and can be used as a preventive agent as well as a therapeutic agent. The mechanism of action of kasugamycin is to disturb the esterase system of pathogen metabolism of amino acids, reducing the biosynthesis of protein. This reduces growth and suppresses mycelia in addition to causing cell granulation, thus resulting in the pathogen losing breeding and infection ability.

Kasugamycin is quite valued both at home and industrial level. Unfortunately, no single bactericide and fungicide is useful in all situations and repeated usage of a single bactericide or fungicide frequently leads to the development of resistance to that compound and their related bactericide and fungicide compounds. Kasugamycin is an antibiotic, therefore development of resistance in pathogen populations remains a concern. A recurrent problem with antibiotic use on crop plants in the past has been the development of resistance among bacterial pathogen strains.

Significant efforts have been proposed towards finding new and improved combinations of bactericides and/or fungicides that are safe, have better performance, require lower dosages, are easier to use and are cost effective. However, none of the current approaches or reports seem to satisfy the existing needs.

There is therefore an unmet need in the art to develop a synergistic agricultural composition including kasugamycin that overcomes the drawbacks associated with the existing agricultural compositions and to provide a synergistic broad-spectrum anti-microbial effect.

The present disclosure satisfies the existing needs, as well as others, and generally overcomes the deficiencies found in the prior art.

### SUMMARY

The present disclosure relates to agricultural compositions and combinations comprising kasugamycin and copper salts. Particularly, the present disclosure provides a synergistic agricultural composition including kasugamycin or a salt thereof, and a copper salt that exhibits wide spectrum anti-microbial properties against phytopathogens. Further aspects of the present disclosure relate to a synergistic antifungal and antibacterial agricultural formulation and a method of preparation thereof.

The present disclosure is based on the surprising finding that agricultural compositions or combinations including kasugamycin or a salt thereof, and a copper salt exhibits synergistic anti-microbial properties, while substantially precluding development of resistance in phytopathogens to kasugamycin and aiding in preventing phytotoxicity caused by kasugamycin. The inclusion of a copper salt in the composition may also confer nutritional value.

Accordingly, an aspect of the present disclosure provides an agricultural combination comprising an agriculturally effective amount of kasugamycin or a salt thereof, an agriculturally effective amount of a copper compound; and an agriculturally acceptable excipient.

In an aspect, the combination comprises kasugamycin or a salt thereof and a copper salt in a weight ratio ranging from 1:1 to 1:30. In another aspect, the combination comprises kasugamycin or a salt thereof and a copper salt in a weight ratio ranging from 1:1 to 1:10.

Accordingly, an aspect of the present disclosure provides an agricultural composition comprising an agriculturally effective amount of kasugamycin or a salt thereof, an agriculturally effective amount of a copper salt; and an agriculturally acceptable excipient.

In an aspect, the composition comprises kasugamycin or a salt thereof and a copper salt in a weight ratio ranging from 1:1 to 1:30. In an aspect, the composition comprises kasugamycin or a salt thereof and a copper compound in a weight ratio ranging from 1:1 to 1:20. In another aspect, the composition comprises kasugamycin or a salt thereof and a copper salt in a weight ratio ranging from 1:1 to 1:10.

In an aspect, the composition comprises kasugamycin or a salt thereof and a copper salt in a weight ratio ranging from 1:30 to 10:1. In an aspect, the composition comprises kasugamycin or a salt thereof and a copper salt in a weight ratio ranging from 1:20 to 10:1.

An aspect of the present disclosure provides an agricultural composition comprising kasugamycin or a salt thereof and a copper compound in a weight ratio ranging from 1:1 to 10:1.

In another aspect, the composition exhibits wide spectrum anti-microbial properties including antifungal and antibacterial properties.

Accordingly, the composition of the present disclosure is effective against Pseudomonas syringae, Xanthomonas spp., Erwinia amylovora, Erwinia carotovora, Xanthomonas axonopodispv, Vesicatoria, Burkholderia andropogonis, Streptomyces scabies, and combinations thereof.

Further, the composition of the present disclosure is effective against Pyricularia oryzae, Alternaria sp, Fusarium sp., and such other fungi, and combinations thereof.

In an aspect, the composition comprises kasugamycin or a salt thereof, a copper salt; and an agriculturally acceptable excipient, such that the composition has a weight ratio of kasugamycin and the copper salt ranging from 1:1 to 1:10.

In another aspect, the composition comprises kasugamycin or a salt thereof, a copper salt; and an agriculturally acceptable excipient, such that the composition has a weight ratio of kasugamycin and the copper salt ranging from 1:1 to 1:6.

In a further aspect, the composition comprises kasugamycin or a salt thereof, a copper salt; and an agriculturally acceptable excipient, such that the composition has a weight ratio of kasugamycin and the copper salt ranging from 1:1 to 1:5.

In one aspect, the composition comprises kasugamycin hydrochloride hydrate, and one or more copper salts selected from copper glycinate, copper monoglycinate, copper diglycinate, copper sulphate, tribasic copper sulphate, copper nitrate, copper chloride, copper oxychloride, copper hydroxide or a combination of the foregoing copper salts.

In one more aspect, the composition comprises kasugamycin hydrochloride hydrate; copper glycinate; and an agriculturally acceptable excipient.

In an aspect, the composition is a liquid formulation.

Exemplary agriculturally acceptable excipients include a surfactant, a preservative, a coloring agent, a pH adjusting agent, a solvent, and combinations thereof.

In one more aspect, the present disclosure provides for controlling phytopathogen growth using the present agricultural composition.

Various objects, features, aspects and advantages of the inventive subject matter will become more apparent from the following detailed description of preferred embodiments.

### DETAILED DESCRIPTION

The following is a detailed description of embodiments of the present invention. The embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

In any aspect or embodiment described hereinbelow, the phrase comprising may be replaced by the phrases “consisting of” or “consisting essentially of” or “consisting substantially of”. In these aspects or embodiment, the composition described includes or comprises or consists of or consists essentially of or consists substantially of the specific components recited therein, to the exclusion of other ingredients or excipients not specifically recited therein.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

The headings and abstract of the invention provided herein are for convenience only and do not interpret the scope or meaning of the embodiments.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The term ‘plant’ refers to all physical parts of a plant, including seeds, seedlings, saplings, roots, tubers, stems, stalks, foliage, and fruits. The term plant includes transgenic and non-transgenic plants.

The term “locus” of a plant as used herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The glycinate salt of copper is understood to refer to a monoglycinate salt or a diglycinate salt or a triglycinate salt of copper.

“Alkyl” as used herein means a straight or branched chain saturated aliphatic hydrocarbon having the specified number of carbon atoms. Alkyl groups include, for example, groups having from 1 to 50 carbon atoms (C₁ to C₅₀ alkyl).

“Alkylene” means a straight, branched or cyclic divalent aliphatic hydrocarbon group, and may have from 1 to about 18 carbon atoms, more specifically 2 to about 12 carbons. Exemplary alkylene groups include methylene (—CH₂—), ethylene (—CH₂CH₂—), propylene (—(CH₂)₃), cyclohexylene (—C₆H₁₀—), methylenedioxy (—O—CH₂—O—), or ethylenedioxy (—O—(CH₂)₂—O—).

“Aryloxy” means an aryl moiety that is linked via an oxygen (i.e., —O-aryl). An aryloxy group includes a C₆ to C₃₀ aryloxy group, and specifically a C₆ to C₁₈ aryloxy group. Non-limiting examples include phenoxy, naphthyloxy, and tetrahydronaphthyloxy.

Various terms as used herein are shown below. To the extent a term used in a claim is not defined below, it should be given the broadest definition persons in the pertinent art have given that term as reflected in printed publications and issued patents at the time of filing.

The present disclosure relates to agricultural compositions. Particularly, the present disclosure provides a synergistic agricultural composition including kasugamycin or a salt thereof and a copper salt that exhibits wide spectrum anti-microbial properties, including antifungal and antibacterial properties. Further aspects of the present disclosure relate to a synergistic antifungal and antibacterial agricultural formulation and a method of preparation thereof.

The present disclosure is on the premise of the unexpected finding by the inventors that agricultural compositions comprising kasugamycin or a salt thereof, and a copper salt exhibit synergistic anti-microbial property, i.e. antifungal and antibacterial properties, while substantially precluding the development of resistance of phytopathogens to kasugamycin and aiding in preventing phytotoxicity caused by kasugamycin. The inclusion of a copper salt in the composition additionally confers nutritional value to the plant. The presence of a copper glycinate salt in the agricultural composition of the present invention showed surprising enhancement in its efficacy against phytopathogens, specifically in comparison to other copper salts.

Accordingly, an aspect of the present disclosure provides an agricultural combination comprising an agriculturally effective amount of kasugamycin or a salt thereof, an agriculturally effective amount of a copper compound; and an agriculturally acceptable excipient.

Accordingly, an embodiment of the present disclosure provides an agricultural combination comprising an agriculturally effective amount of kasugamycin or a salt thereof; an agriculturally effective amount of a copper salt; and an agriculturally acceptable excipient.

In an embodiment, the combination comprises kasugamycin or a salt thereof and a copper salt in a weight ratio ranging from 1:1 to 1:30. In another embodiment, the combination comprises kasugamycin or a salt thereof and a copper salt in a weight ratio ranging from 1:1 to 1:10.

In a preferred embodiment, the combination comprises kasugamycin or a salt thereof and a copper salt in a weight ratio of 1:8.

In an embodiment, the salt of kasugamycin is kasugamycin hydrochloride hydrate.

In an embodiment, the copper salt comprises copper glycinate, copper monoglycinate, copper diglycinate, copper sulphate, tribasic copper sulphate, copper nitrate, copper hydroxide, copper oxychloride, copper chloride or a combination thereof.

In a preferred embodiment, the combination comprises kasugamycin or a salt thereof and copper glycinate in a weight ratio of 1:8.

In an embodiment, the combination comprises kasugamycin or a salt thereof in an amount ranging from about 0.1% to about 40% by weight (w/v).

In an embodiment, the combination comprises kasugamycin or a salt thereof in an amount ranging from about 1% to about 30% by weight (w/v) of the combination.

In a preferred embodiment, the combination comprises kasugamycin or a salt thereof in an amount ranging from about 2% to about 10% by weight (w/v) of the combination.

In an embodiment, the combination comprises a copper salt in an amount ranging from about 1% to about 40% by weight (w/v) of the combination.

In an embodiment, the combination comprises a copper salt in an amount ranging from about 10% to about 20% by weight (w/v) of the combination.

In an embodiment, the combination comprises a copper glycinate salt in an amount ranging from about 1% to about 30% by weight (w/v) of the combination.

In a preferred embodiment, the combination comprises a copper glycinate salt in an amount ranging from about 10% to about 20% by weight (w/v) of the combination.

The present disclosure provides an agricultural composition comprising an agriculturally effective amount of kasugamycin or a salt thereof, an agriculturally effective amount of a copper compound; and an agriculturally acceptable excipient.

Accordingly, an aspect of the present disclosure provides an agricultural composition comprising an agriculturally effective amount of kasugamycin or a salt thereof, an agriculturally effective amount of a copper salt; and an agriculturally acceptable excipient.

In an embodiment, the composition comprises kasugamycin or a salt thereof and a copper salt in a weight ratio ranging from 1:1 to 10:1.

In an embodiment, the composition comprises kasugamycin or a salt thereof and a copper salt in a weight ratio ranging from 1:20 to 10:1.

In an embodiment, the composition comprises kasugamycin or a salt thereof and a copper salt in a weight ratio ranging from 1:30 to 10:1.

In an embodiment, the composition comprises kasugamycin or a salt thereof, a copper salt; and an agriculturally acceptable excipient, such that the composition has a weight ratio of kasugamycin and a copper salt ranging from 1:1 to 1:30.

In an embodiment, the composition comprises kasugamycin or a salt thereof, a copper salt; and an agriculturally acceptable excipient, such that the composition has a weight ratio of kasugamycin and a copper salt ranging from 1:1 to 1:20.

In a preferred embodiment, the composition comprises kasugamycin or a salt thereof; a copper salt; and an agriculturally acceptable excipient, such that the composition has a weight ratio of kasugamycin and a copper salt ranging from 1:1 to 1:10.

In another embodiment, the composition comprises kasugamycin or a salt thereof, a copper salt; and an agriculturally acceptable excipient, such that the composition has a weight ratio of kasugamycin and a copper salt ranging from 1:1 to 1:6.

In a further embodiment, the composition comprises kasugamycin or a salt thereof, a copper salt; and an agriculturally acceptable excipient, such that the composition has a weight ratio of kasugamycin:copper salt ranging from 1:1 to 1:5.

In a preferred embodiment, the composition comprises kasugamycin or a salt thereof; a copper salt; and an agriculturally acceptable excipient, such that the composition of kasugamycin and the copper salt has a weight ratio of 1:8.

In an embodiment, the salt of kasugamycin is kasugamycin hydrochloride.

In an embodiment, the salt of kasugamycin is kasugamycin hydrochloride hydrate.

In an embodiment, the copper salt comprises copper glycinate, copper monoglycinate, copper diglycinate, copper sulphate, tribasic copper sulphate, copper nitrate, copper hydroxide, copper oxychloride, copper chloride or a combination thereof.

In an embodiment, the salt of copper comprises copper glycinate.

In an embodiment, the salt of copper is copper monoglycinate.

In an embodiment, the salt of copper is copper diglycinate.

In an embodiment, the salt of copper is copper triglycinate.

In an embodiment, the composition comprises kasugamycin hydrochloride hydrate; copper glycinate, copper nitrate, copper chloride, or a combination thereof, and an agriculturally acceptable excipient.

In an embodiment, the composition comprises kasugamycin hydrochloride hydrate; a copper salt selected from copper glycinate, copper monoglycinate, copper diglycinate, copper triglycinate, copper nitrate, copper chloride, copper oxychloride, copper hydroxide, copper sulphate, tribasic copper sulphate or a combination thereof, and an agriculturally acceptable excipient.

In a preferred embodiment, the composition comprises kasugamycin hydrochloride hydrate; copper glycinate; and an agriculturally acceptable excipient.

In a preferred embodiment, the composition comprises kasugamycin hydrochloride hydrate; copper monoglycinate; and an agriculturally acceptable excipient.

In another preferred embodiment, the composition comprises kasugamycin hydrochloride hydrate; copper diglycinate; and an agriculturally acceptable excipient.

In an embodiment, the composition comprises kasugamycin or a salt thereof in an amount ranging from about 0.1% to about 40% by weight (w/v) of the composition.

In an embodiment, the composition comprises kasugamycin or a salt thereof in an amount ranging from about 1% to about 30% by weight (w/v) of the composition.

In an embodiment, the composition comprises kasugamycin or a salt thereof in an amount ranging from about 2% to about 15% by weight (w/v) of the composition.

In a preferred embodiment, the composition comprises kasugamycin or a salt thereof in an amount ranging from about 2% to about 10% by weight (w/v) of the composition.

In an embodiment, the composition comprises kasugamycin hydrochloride in an amount ranging from about 0.1% to about 40% by weight (w/v) of the composition.

In an embodiment, the composition comprises kasugamycin hydrochloride in an amount ranging from about 1% to about 30% by weight (w/v) of the composition.

In an embodiment, the composition comprises kasugamycin hydrochloride in an amount ranging from about 2% to about 20% by weight (w/v) of the composition.

In a preferred embodiment, the composition comprises kasugamycin hydrochloride in an amount ranging from about 2% to about 10% by weight (w/v) of the composition.

In an embodiment, the composition comprises a copper salt in an amount ranging from about 0.1% to about 50% by weight (w/v) of the composition.

In an embodiment, the composition comprises a copper salt in an amount ranging from about 1% to about 40% by weight (w/v) of the composition.

In an embodiment, the composition comprises a copper salt in an amount ranging from about 5% to about 30% by weight (w/v) of the composition.

In a preferred embodiment, the composition comprises a copper salt in an amount ranging from about 10% to about 20% by weight (w/v) of the composition.

In an embodiment, the composition comprises a copper glycinate salt in an amount ranging from about 1% to about 30% by weight (w/v) of the composition.

In a preferred embodiment, the composition comprises a copper glycinate salt in an amount ranging from about 10% to about 20% by weight (w/v) of the composition.

In an embodiment the present compositions further comprising an herbicide, fungicide, insecticide, nematicide, acaricides or combinations thereof.

In an embodiment the insecticide may be selected from group of Acetylcholinesterase (AChE) inhibitors, GABA-gated chloride channel blockers, Sodium channel modulators, Nicotinic acetylcholine receptor (nAChR) competitive modulators, Nicotinic acetylcholine receptor (nAChR) allosteric modulators—Site I, Glutamate-gated chloride channel (GluCl) allosteric modulators, Juvenile hormone mimics, Miscellaneous nonspecific (multi-site) inhibitors, Chordotonal organ TRPV channel modulators, Mite growth inhibitors affecting CHS1, Microbial disruptors of insect midgut membranes, Inhibitors of mitochondrial ATP synthase, Uncouplers of oxidative phosphorylation via disruption of the proton gradient, Nicotinic acetylcholine receptor (nAChR) channel blockers, Inhibitors of chitin biosynthesis affecting CHS1. Inhibitors of chitin biosynthesis, Moulting disruptors, Dipteran, Ecdysone receptor agonists, Octopamine receptor agonists, Mitochondrial complex III electron transport inhibitors, Mitochondrial complex I electron transport inhibitors, Voltage-dependent sodium channel blockers, Inhibitors of acetyl CoA carboxylase, Mitochondrial complex IV electron transport inhibitors, Mitochondrial complex II electron transport inhibitors, Ryanodine receptor modulators, Chordotonal organ Modulators—undefined target site, GABA-gated chloride channel allosteric modulators and Baculoviruses.

In an embodiment, the fungicide may be selected from nucleic acid synthesis inhibitors, cytoskeleton and motor protein inhibitors, amino acids and protein synthesis inhibitors, respiration process inhibitors, signal transduction inhibitors, lipid synthesis or transport and membrane integrity disruptors or functions, sterol biosynthesis inhibitors, melanin synthesis inhibitors, cell wall biosynthesis inhibitors, melanin synthesis inhibitor in cell wall, host plant defence inductors, fungicides with unknown modes of action, non-classified fungicides, fungicides with multisite activity and/or biologicals with multiple mode of action.

In an embodiment, the herbicide may be selected from a isoxazolidinone herbicide, a urea herbicide, a triazine herbicide, a hydroxybenzonitrile herbicide, a thiocarbamate herbicide, a pyridazine herbicide, chloroacetanilide herbicides; benzothiazole herbicides; carbanilate herbicides, cyclohexene oxime herbicides; picolinic acid herbicides; pyridine herbicides; quinolinecarboxylic acid herbicides; chlorotriazine herbicides, aryloxyphenoxypropionic herbicides, oxadiazolone herbicides; phenylurea herbicides, sulfonanilide herbicides; triazolopyrimidine herbicides, amide herbicides, pyridazine herbicides, dinitroaniline herbicides or combinations thereof.

In an embodiment, the agriculturally acceptable excipient includes any or a combination comprising a wetting agent, a dispersing agent, a binding agent, a surfactant/emulsifier, an anti-freeze agent, a mineral, a filler, a preservative, a coloring agent, and a pH adjusting agent. However, it should be appreciated that any other agriculturally acceptable excipients, as known to a person skilled in the art, may be used to serve its intended purpose.

In an embodiment, the agriculturally acceptable excipients are present in an amount ranging from 10% to 99% w/v of the composition.

In an embodiment, the agriculturally acceptable excipients are present in an amount ranging from 10% to 50% w/v of the composition.

The wetting agents may include, but are not limited to, any or a combination comprising sulfosuccinates, naphthalene sulfonates, sulfated esters, phosphate esters, sulfated alcohols, and alkyl benzene sulfonates.

The dispersing agents may include, but are not limited to, any or a combination comprising polycarboxylates, naphthalene sulfonate condensates, phenol sulfonic acid condensates, lignosulfonates, methyl oleyl taurates, and polyvinyl alcohols.

The binding agents may include, but are not limited to, any or a combination comprising polyvinyl alcohols, phenyl naphthalene sulphonates, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymers, propylene oxide copolymers, polyethylene glycols, and polyethylene oxides.

The anti-freeze agents may include, but are not limited to, one or more of ethylene glycol, propylene glycol, urea, glycerin, and anti-freeze proteins.

The surfactants may include any or a combination comprising ionic surfactants and non-ionic surfactants. Non-limiting examples of ionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonates, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates. Non-limiting examples of the non-ionic surfactants include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpyrolidones, sorbitan fatty acid alcohol ethoxylates and sorbitan fatty acid ester ethoxylates.

The minerals may include, but are not limited to, any or a combination of kaolin, silica, titanium (IV) oxide, rutile, anatase, aluminum oxides, aluminum hydroxides, iron oxide, iron sulfide, magnetite, pyrite, hematite, ferrite, greigite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, and indium tin oxide.

The fillers may include, but are not limited to, any or a combination of diatomaceous earth, kaolin, bentonite, precipitated silica, attapulgite, and perlite.

The advantageous agricultural composition of the present disclosure can be formulated in any of formulations such as aqueous formulations, aerosols, emulsifiable concentrates, wettable powders, soluble concentrates, soluble powders, suspension concentrates, spray concentrates, capsule suspensions, water dispersible granules, granules, dusts, microgranule seed treatment formulations, and the like as known to persons skilled in the art.

In an embodiment, the composition is formulated as liquid formulation.

In an embodiment, the composition is formulated as a non-aqueous solution.

In a preferred embodiment, the composition is formulated as an aqueous solution.

In an embodiment, the liquid agricultural composition comprises an agriculturally acceptable excipient including one or a combination of a surfactant, a preservative, a coloring agent, a pH adjusting agent, and a solvent.

In an embodiment, the present disclosure provides a liquid agricultural composition comprising kasugamycin or a salt thereof, a copper compound; and an agriculturally acceptable excipient, said composition having weight ratio of kasugamycin to the copper compound ranging from 1:1 to 10:1.

In an embodiment, the present disclosure provides a liquid agricultural composition comprising kasugamycin or a salt thereof; a copper salt; and an agriculturally acceptable excipient, said composition having weight ratio of kasugamycin and a copper salt ranging from 1:1 to 10:1.

In an embodiment, the present disclosure provides a liquid agricultural composition comprising kasugamycin or a salt thereof; a copper salt; and an agriculturally acceptable excipient, said composition having weight ratio of kasugamycin and a copper salt ranging from 1:1 to 1:30.

In a preferred embodiment, the present disclosure provides a liquid agricultural composition comprising kasugamycin or a salt thereof, a copper salt; and an agriculturally acceptable excipient, said composition having weight ratio of kasugamycin and a copper salt ranging from 1:1 to 1:10.

In an embodiment, the present disclosure provides a liquid agricultural composition comprising kasugamycin or a salt thereof, copper glycinate; and an agriculturally acceptable excipient, said composition having weight ratio of kasugamycin and copper glycinate ranging from 1:1 to 10:1.

In an embodiment, the present disclosure provides a liquid agricultural composition comprising kasugamycin or a salt thereof, copper glycinate; and an agriculturally acceptable excipient, said composition having weight ratio of kasugamycin and copper glycinate ranging from 1:1 to 1:30.

In a preferred embodiment, the present disclosure provides a liquid agricultural composition comprising kasugamycin or a salt thereof, copper glycinate; and an agriculturally acceptable excipient, said composition having weight ratio of kasugamycin and copper glycinate ranging from 1:1 to 1:10.

In one preferred embodiment, the present disclosure provides a liquid agricultural composition comprising kasugamycin or a salt thereof, copper glycinate; and an agriculturally acceptable excipient, said composition having weight ratio of kasugamycin and copper glycinate of 1:8.

In one preferred embodiment, the present disclosure provides a liquid agricultural composition comprising kasugamycin or a salt thereof, copper monoglycinate; and an agriculturally acceptable excipient, said composition having weight ratio of kasugamycin and copper monoglycinate ranging from 1:1 to 1:10.

In one preferred embodiment, the present disclosure provides a liquid agricultural composition comprising kasugamycin or a salt thereof, copper monoglycinate; and an agriculturally acceptable excipient, said composition having weight ratio of kasugamycin and copper monoglycinate of 1:8.

In one more preferred embodiment, the present disclosure provides a liquid agricultural composition comprising kasugamycin or a salt thereof; copper diglycinate; and an agriculturally acceptable excipient, said composition having weight ratio of kasugamycin and copper diglycinate ranging from 1:1 to 1:10.

In one more preferred embodiment, the present disclosure provides a liquid agricultural composition comprising kasugamycin or a salt thereof; copper diglycinate; and an agriculturally acceptable excipient, said composition having weight ratio of kasugamycin and copper diglycinate of 1:8.

In an embodiment, the liquid agricultural composition comprises an agriculturally acceptable excipient including one or a combination of a surfactant, a preservative, a coloring agent, a pH adjusting agent, and a solvent.

In an embodiment, the surfactant includes an alkyl phenyl ether and a polyol.

In an embodiment, the surfactant including an alkyl phenyl ether and a polyol comprises 1% to 20% w/v of the composition.

In an embodiment, the surfactant including an alkyl phenyl ether and a polyol comprises 5% to 15% w/v of the composition.

In an embodiment, the present composition comprises at least one polyol and the polyol is selected from an acyclic polyol and a cyclic polyol.

Examples of such polyol compounds include sugars, sugar alcohols, sugar acids and uronic acids. Preferred polyols are sugars, sugar alcohols and sugar acids, including, but not limited to mannitol, glycerin, xylitol, and sorbitol.

The polyol may comprise ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A, and the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, polyether polyol, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, and octaglycerol may be employed.

In an embodiment, the surfactant includes an alkyl phenyl ether and ethylene glycol.

In an embodiment, the preservative includes potassium sorbate.

In an embodiment, the solvent includes water.

In an embodiment, the composition exhibits wide spectrum antimicrobial properties.

In an embodiment, the composition exhibits wide spectrum antifungal and antibacterial properties.

Another aspect of the present disclosure provides a synergistic antimicrobial agricultural composition comprising kasugamycin or a salt thereof, a copper salt; and an agriculturally acceptable excipient, said composition having weight ratio of kasugamycin:copper salt ranging from 1:1 to 1:30.

Another aspect of the present disclosure provides a synergistic antimicrobial agricultural composition comprising kasugamycin or a salt thereof, a copper salt; and an agriculturally acceptable excipient, said composition having weight ratio of kasugamycin:copper salt ranging from 1:1 to 1:10.

Another aspect of the present disclosure provides a synergistic antimicrobial composition comprising kasugamycin or a salt thereof, copper glycinate; and an agriculturally acceptable excipient, said composition having weight ratio of kasugamycin and copper ranging salt from 1:1 to 1:10.

In an embodiment, the formulation is an aqueous formulation.

In an embodiment, the agriculturally acceptable excipient includes any or a combination of a surfactant, a preservative, a coloring agent, a pH adjusting agent, and a solvent.

In an embodiment, the surfactant includes alkyl phenyl ether and ethylene glycol.

In an embodiment, the preservative includes potassium sorbate.

In an embodiment, the solvent includes water.

In an embodiment, the formulation has a pH ranging from 1.5 to 5.5.

The agricultural benefit may be accrued by treating a seed, a plant, a plant part, a soil, or a combination thereof, with a combination or composition or formulation of the present disclosure under conditions leading to association between the composition and the seed, plant, plant part, soil, or combinations thereof. Application of a formulation to a target can be accomplished using any delivery method known in the art including, but not limited to dusting, fumigation, granule application, injection, misting, seed treatment, spraying, dipping, or coating.

In an embodiment, the present disclosure provides a method of reducing resistance in phytopathogens to anti-microbial agents.

In an embodiment, the present disclosure provides a method of resistance management or reducing resistance in phytopathogens comprising applying at a locus of an infection by the phytopathogen or to a plant or a plant part or a plant propagation material a composition comprising;
(i) kasugamycin or a salt thereof, and
(ii) a copper salt;
   wherein the weight ratio of kasugamycin or the salt thereof and the copper salt is from 1:1 to 1:30.

In an embodiment, the present disclosure provides a method of resistance management or reducing resistance in phytopathogens comprising applying at a locus of an infection by the phytopathogen or to a plant or a plant part or a plant propagation material a combination comprising;
(i) kasugamycin or a salt thereof, and
(ii) a copper salt;
   wherein the weight ratio of kasugamycin or a salt thereof and the copper salt is from 1:1 to 1:30.

In a preferred embodiment, the present disclosure provides a method of resistance management or reducing resistance in phytopathogens comprising applying at the locus of the infection by the phytopathogen or a plant or a plant part or a plant propagation material a composition or combination comprising;
(i) kasugamycin or a salt thereof, and
(ii) a copper salt;
   wherein the weight ratio of kasugamycin or a salt thereof and the copper salt is from 1:1 to 1:10.

In an embodiment, the present disclosure provides a method of resistance management or reducing resistance in phytopathogens comprising applying at the locus of an infection by the phytopathogens or to a plant or to a plant part or to a plant propagation material a composition or combination comprising;
(i) kasugamycin or a salt thereof and
(ii) copper glycinate;
   wherein the weight ratio of kasugamycin or a salt thereof and the copper glycinate is ranging from 1:1 to 1:30.

In a preferred embodiment, the present disclosure provides a method of resistance management or reducing resistance in phytopathogens comprising applying at the locus of an infection by the phytopathogens or to a plant or to a plant part or to a plant propagation material a composition or combination comprising;
(iii) kasugamycin or a salt thereof and
(iv) copper glycinate;
   wherein the weight ratio of kasugamycin or a salt thereof and the copper glycinate is ranging from 1:1 to 1:10.

In a preferred embodiment, the present disclosure provides a method of resistance management or reducing resistance in phytopathogens comprising applying at the locus of an infection by the phytopathogens or to a plant or to a plant part or to a plant propagation material a composition or combination comprising;
(i) kasugamycin or a salt thereof and
(ii) copper glycinate;
   wherein the weight ratio of kasugamycin or the salt thereof and the copper glycinate is 1:8.

In an embodiment, the present disclosure provides a method of resistance management or of reducing resistance in phytopathogens comprising applying at the locus of an infection by the phytopathogens or to a plant or to a plant part or to a plant propagation material a composition or combination comprising;
(i) kasugamycin or a salt thereof and
(ii) copper monoglycinate;
   wherein the weight ratio of kasugamycin or the salt thereof and the copper monoglycinate is ranging from 1:1 to 1:10.

In an embodiment, the present disclosure provides a method of resistance management or reducing resistance in phytopathogens comprising applying at the locus of an infection by the phytopathogens or to a plant or to a plant part or to a plant propagation material a composition comprising;
(i) kasugamycin or a salt thereof and
(ii) copper diglycinate;
   wherein the weight ratio of kasugamycin or the salt thereof and the copper diglycinate is ranging from 1:1 to 1:10.

In a preferred embodiment, the present disclosure provides a method of resistance management or reducing resistance in phytopathogens comprising applying at the locus of the infection by the phytopathogen or a plant or a plant part or a plant propagation material a liquid composition comprising;
(iii) kasugamycin or a salt thereof, and
(iv) a copper salt;
   wherein the weight ratio of kasugamycin or the salt thereof and the copper salt is from 1:1 to 1:10.

In an embodiment, the present disclosure provides a method of controlling or inhibiting phytopathogens, comprising applying the compositions described herein to the said plant or plant part or plant propagation material or to the locus thereof.

In an embodiment, the present disclosure provides a method of controlling or inhibiting phytopathogens comprising applying at the locus of the infection by the phytopathogen or a plant or a plant part or a plant propagation material a composition comprising;
(i) kasugamycin or a salt thereof, and
(ii) a copper salt;
   wherein the weight ratio of kasugamycin or the salt thereof and the copper salt is from 1:1 to 1:30.

In an embodiment, the present disclosure provides a method of controlling or inhibiting phytopathogens comprising applying at the locus of the infection by the phytopathogen or a plant or a plant part or a plant propagation material a combination comprising;
(i) kasugamycin or a salt thereof, and
(ii) a copper salt;
   wherein the weight ratio of kasugamycin or the salt thereof and the copper salt is from 1:1 to 1:30.

In an embodiment, the present disclosure provides a method of controlling or inhibiting phytopathogens comprising applying at the locus of the infection by the phytopathogen or a plant or a plant part or a plant propagation material a combination or composition comprising;
(iii) kasugamycin or a salt thereof, and
(iv) a copper salt;
   wherein the weight ratio of kasugamycin or the salt thereof and the copper salt is from 1:1 to 1:10.

In an embodiment, the present disclosure provides a method of controlling or inhibiting phytopathogens comprising applying at the locus of the infection by the phytopathogen or a plant or a plant part or a plant propagation material a combination or composition comprising;
(v) kasugamycin or a salt thereof, and
(vi) a copper salt;
   wherein the weight ratio of kasugamycin or the salt thereof and the copper salt is 1:8.

In an embodiment, the present disclosure provides a method of controlling or inhibiting phytopathogens comprising applying at the locus of the infection by the phytopathogen or a plant or a plant part or a plant propagation material a combination or composition comprising;
(i) kasugamycin or a salt thereof and
(ii) a copper glycinate salt;
   wherein the weight ratio of kasugamycin or the salt thereof and the copper glycinate salt is from 1:1 to 1:30.

In a preferred embodiment, the present disclosure provides a method of controlling or inhibiting phytopathogens comprising applying at the locus of the infection by the phytopathogen or a plant or a plant part or a plant propagation material a combination or composition comprising;
(i) kasugamycin or a salt thereof and
(ii) a copper glycinate salt;
   wherein the weight ratio of kasugamycin or the salt thereof and the copper glycinate salt is from 1:1 to 1:10.

In a preferred embodiment, the present disclosure provides a method of controlling or inhibiting phytopathogens comprising applying at the locus of the infection by the phytopathogen or a plant or a plant part or a plant propagation material a combination or composition comprising;
(iii) kasugamycin or a salt thereof and
(iv) a copper glycinate salt;
   wherein the weight ratio of kasugamycin or salt thereof and the copper glycinate salt is 1:8.

In a preferred embodiment, the present disclosure provides a method of controlling or inhibiting phytopathogens comprising applying at the locus of the infection by the phytopathogen or a plant or a plant part or a plant propagation material a combination or composition comprising;
(i) kasugamycin or a salt thereof and
(ii) a copper glycinate salt;
   wherein the weight ratio of kasugamycin or the salt thereof and the copper glycinate salt is 1:8.

In an embodiment, the present disclosure provides a method of controlling or inhibiting phytopathogens comprising applying at the locus of the infection by the phytopathogen or to a plant or a plant part or a plant propagation material a combination or composition comprising;
(i) kasugamycin or a salt thereof, and
(ii) a copper glycinate salt;
   wherein the weight ratio of kasugamycin or the salt thereof and the copper glycinate salt is from 1:1 to 1:30, wherein the said method comprises applying the kasugamycin or the salt thereof at a dosage ranging from 1 to 10 g/kg of kasugamycin and copper glycinate at a dosage ranging from 5 to 20 g/kg of copper.

In a preferred embodiment, the present disclosure provides a method of controlling or inhibiting phytopathogens comprising applying at the locus of the infection by the phytopathogen or to a plant or a plant part or a plant propagation material a combination or composition comprising;
(i) kasugamycin or a salt thereof, and
(ii) a copper glycinate salt;
   wherein the weight ratio of kasugamycin or the salt thereof and the copper glycinate salt is from 1:1 to 1:10, wherein the said method comprises applying the kasugamycin or the salt thereof at a dosage ranging from 1 to 10 g/kg of kasugamycin and copper glycinate at a dosage ranging from 5 to 20 g/kg of copper.

In a preferred embodiment, the present disclosure provides a method of controlling or inhibiting phytopathogens comprising applying at the locus of the infection by the phytopathogen or to a plant or a plant part or a plant propagation material a combination or composition comprising;
(i) kasugamycin or a salt thereof, and
(ii) a copper glycinate salt;
   wherein the weight ratio of kasugamycin or the salt thereof and the copper glycinate salt is 1:8, wherein the said method comprises applying the kasugamycin or the salt thereof at a dosage ranging from 2 to 5 g/kg of kasugamycin and the copper glycinate at a dosage ranging from 10 to 20 g/kg of copper.

In a preferred embodiment, the present disclosure provides a method of controlling phytopathogens comprising applying at the locus of the infection by the phytopathogen or to a plant or to a plant part or to a plant propagation material a liquid composition comprising;
(i) kasugamycin or a salt thereof and
(ii) copper glycinate;
   wherein the weight ratio of kasugamycin or a salt thereof and the copper glycinate is ranging from 1:1 to 1:10, wherein the said method comprises applying the kasugamycin or the salt thereof at a dosage ranging from 2 to 5 g/kg of kasugamycin and the copper glycinate at a dosage ranging from 10 to 20 g/kg of copper.

In a preferred embodiment, the present disclosure provides a method of controlling phytopathogens comprising applying at the locus of the infection by the phytopathogen or to a plant or to a plant part or to a plant propagation material a liquid composition comprising;
(i) kasugamycin or a salt thereof and
(ii) copper glycinate;
   wherein the weight ratio of kasugamycin or a salt thereof and the copper glycinate is 1:8, wherein the said method comprises applying the kasugamycin or the salt thereof at a dosage ranging from 2 to 5 g/kg of kasugamycin and the copper glycinate at a dosage ranging from 10 to 20 g/kg of copper.

The combinations of the present disclosure provide the agricultural composition as a pre-mix composition or a kit of parts such that individual actives may be mixed before spraying. Alternatively, the kit of parts may contain the kasugamycin or a salt thereof or the copper compound or a salt thereof, more specifically copper glycinate, or a combination thereof, pre-mixed and an optional third active may be admixed with an adjuvant or an agrochemical or a fertilizer compound such that the two components may be tank mixed before spraying.

In an embodiment, the present disclosure provides a kit-of-parts comprising an agricultural combination of kasugamycin or a salt thereof, and a copper salt.

In an embodiment, the present disclosure provides a kit-of-parts comprising an agricultural combination of kasugamycin or a salt thereof, and a copper glycinate salt.

The method of the present disclosure may be used to control a broad spectrum of plant diseases.

Diseases in rice include blast (Magnaporthe grisea), Helminthosporium leaf spot (Cochliobolus miyabeanus), sheath blight (Rhizoctonia solani), and bakanae disease (Gibberella fujikuroi).

Diseases in wheat include powdery mildew (Erysiphe graminis), Fusariuin head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), Septoria, and yellow spot (Pyrenophora tritici-repentis).

Diseases of barley include powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn include smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis), and Rhizoctonia damping-off (Rhizoctonia solani).

Diseases of citrus include melanose (Diaporthe citri), scab (Elsinoe fawcetti), penicillium rot (Penicillium digitatum, P. italicum), and brown rot (Phytophthora parasitica, Phytophthora citrophthora).

Diseases of apple include blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear include scab (Venturia nashicola, V. pirina), powdery mildew, black spot (Alternaria alternata Japanese pear pathotype), rust (Gymnosporangium haraeanum), and phytophthora fruit rot (Phytophtora cactorum).

Diseases of peach include brown rot (Monilinia fructicola), powdery mildew, scab (Cladosporium carpophilum), and phomopsis rot (Phomopsis sp.).

Diseases of grape include anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon include anthracnose (Gloeosporium kaki), and leaf spot (Cercospora kaki, Mycosphaerella nawae).

Diseases of gourd include anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.).

Diseases of tomato include early blight (Alternaria solani), leaf mold (Cladosporium fulvum), and late blight (Phytophthora infestans).

Diseases of eggplant include brown spot (Phomopsis vexans), and powdery mildew (Erysiphe cichoracearum)

Diseases of cruciferous vegetables include Alternaria leaf spot (Alternaria japonica), white spot (Cercosporella brassicae), clubroot (Plasmodiophora brassicae), and downy mildew (Peronospora parasitica).

Diseases of onion include rust (Puccinia allii), and downy mildew (Peronospora destructor)

Diseases of soybean include purple seed stain (Cercospora kikuchii), Sphaceloma scad (Elsinoe glycines), pod and stem blight (Diaporthe phaseolorum var. sojae), Septoria brown spot (Septoria glycines), frogeye leaf spot (Cercospora sojina), rust (Phakopsora pachyrhizi), Yellow rust, brown stem rot (Phytophthora sojae), and Rhizoctonia damping-off (Rhizoctonia solani).

Diseases of kidney bean include anthracnose (Colletotrichum lindemthianum).

Diseases of peanut include leaf spot (Cercospora personata), brown leaf spot (Cercospora arachidicola) and southern blight (Sclerotium rolfsii).

Diseases of garden pea include powdery mildew (Erysiphe pisi), and root rot (Fusarium solani f. sp. pisi).

Diseases of potato include early blight (Alternaria solani), late blight (Phytophthora infestans), pink rot (Phytophthora erythroseptica), and powdery scab (Spongospora subterranean f. sp. subterranea).

Diseases of strawberry include powdery mildew (Sphaerotheca humuli), and anthracnose (Glomerella cingulata).

Diseases of tea include net blister blight (Exobasidium reticulatum), white scab (Elsinoe leucospila), gray blight (Pestalotiopsis sp.), and anthracnose (Colletotrichum theae-sinensis).

Diseases of tobacco include brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed include Sclerotinia rot (Sclerotinia sclerotiorum), and Rhizoctonia damping-off (Rhizoctonia solani).

Diseases of cotton include Rhizoctonia damping-off (Rhizoctonia solani).

Diseases of sugar beet include Cercospora leaf spot (Cercospora beticola), leaf blight (Thanatephorus cucumeris), root rot (Thanatephorus cucumeris), and Aphanomyces root rot (Aphanomyces cochloides).

Diseases of rose include black spot (Diplocarpon rosae), powdery mildew (Sphaerotheca pannosa), and downy mildew (Peronospora sparsa).

Diseases of Chrysanthemum and asteraceous plants include downy mildew (Bremia lactucae), leaf blight (Septoria chrysanthemi-indici), and white rust (Puccinia horiana).

Diseases of various groups include diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish include Alternaria leaf spot (Alternaria brassicicola).

Diseases of turfgrass include dollar spot (Sclerotinia homeocarpa), and brown patch and large patch (Rhizoctonia solani).

Disease of banana include black sigatoka (Mycosphaerella fijiensis), and yellow sigatoka (Mycosphaerella musicola).

Disease of sunflower include downy mildew (Plasmopara halstedii).

Seed diseases or diseases in the early stages of the growth of various plants may be caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants may be mediated by Polymyxa spp. or Olpidium spp. and so on.

Most plant pathogenic bacteria belong to the following genera: Erwinia, Pectobacterium, Pantoea, Agrobacterium, Pseudomonas, Ralstonia, Burkholderia, Acidovorax, Xanthomonas, Clavibacter, Streptomyces, Xylella, Spiroplasma, and Phytoplasma.

Particularly, the composition of the present disclosure is effective against Pseudomonas syringae, Xanthomonas spp., Erwinia amylovora, Erwinia carotovora, Pyricularia oryzae, Xanthomonas axonopodispv. Vesicatoria, Burkholderia andropogonis, and Streptomyces scabies.

Examples of the crops on which the present compositions may be used used include, are not limited to, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, watermelon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The composition of the present invention maybe applied simultaneously as a tank mix or a formulation or may be applied sequentially. The application may be made to the soil before emergence of the plants, either pre-planting or post-planting. The application may be made as a foliar spray at different timings during crop development, with either one or two applications early or late post-emergence.

The compositions according to the disclosure can be applied before or after infection of the useful plants or the propagation material thereof by fungi, for example.

The combination of kasugamycin with a copper compound, more specifically copper glycinate greatly improved disease control as well as improved yield and demonstrated a synergistic effect.

In an embodiment, the present disclosure provides the use of an agricultural combination/composition for controlling a broad spectrum of phytopathogenic diseases comprising;
(i) kasugamycin or a salt thereof, and
(ii) a copper salt;
   wherein the weight ratio of kasugamycin or a salt thereof and the copper salt is ranging from 1:1 to 1:30.

In an embodiment, the present disclosure provides the use of an agricultural combination/composition for controlling a broad spectrum of phytopathogenic diseases comprising;
(iii) kasugamycin or a salt thereof, and
(iv) a copper salt;
   wherein the weight ratio of kasugamycin or a salt thereof and the copper salt is ranging from 1:1 to 1:10.

In an embodiment, the present invention provides the use of an agricultural combination/composition for controlling a broad spectrum of phytopathogenic diseases comprising;
(i) kasugamycin or a salt thereof and
(ii) copper glycinate;
   wherein the weight ratio of kasugamycin or a salt thereof and the copper glycinate is ranging from 1:1 to 1:30.

In a preferred embodiment, the present invention provides the use of an agricultural combination/composition for controlling a broad spectrum of phytopathogenic diseases comprising;
(i) kasugamycin or a salt thereof and
(ii) copper glycinate;
   wherein the weight ratio of kasugamycin or a salt thereof and the copper glycinate is ranging from 1:1 to 1:10.

In one preferred embodiment, the present invention provides the use of an agricultural combination/composition for controlling a broad spectrum of phytopathogenic diseases comprising;
(iii) kasugamycin or a salt thereof and
(iv) copper glycinate;
   wherein the weight ratio of kasugamycin or a salt thereof and the copper glycinate is 1:8.

In an embodiment, the present invention provides the use of a liquid agricultural composition for controlling a broad spectrum of phytopathogenic diseases comprising;
(i) kasugamycin or a salt thereof and
(ii) a copper salt;
   wherein the weight ratio of kasugamycin or a salt thereof and the copper salt is ranging from 1:1 to 1:30.

In an embodiment, the present invention provides the use of a liquid agricultural composition for controlling a broad spectrum of phytopathogenic diseases comprising;
(i) kasugamycin or a salt thereof and
(ii) copper glycinate;
   wherein the weight ratio of kasugamycin or a salt thereof and the copper salt is from 1:1 to 1:10.

In an embodiment, the present invention provides the use of a liquid agricultural composition for controlling a broad spectrum of phytopathogenic diseases comprising;
(iii) kasugamycin or a salt thereof and
(iv) copper glycinate;
   wherein the weight ratio of kasugamycin or the salt thereof and the copper salt is 1:8.

Moreover, it was observed that the combination of kasugamycin with one or more copper salts inhibited phytopathogenic fungi and bacteria compared to kasugamycin and copper when used individually to control or inhibit phytopathogenic fungi, therefore, indicating a superior advantage of the combination in disease control and inhibition. The absence of phytotoxicity in crops treated with the present composition was also observed.

While the foregoing description discloses various embodiments of the disclosure, other and further embodiments of the invention may be devised without departing from the basic scope of the disclosure. The invention is not limited to the described embodiments, versions or examples, which are included to enable a person having ordinary skill in the art to make and use the invention when combined with information and knowledge available to the person having ordinary skill in the art.

### EXAMPLES

### Example 1—Pre-Mix Formulation

A pre-mix formulation having composition as shown in Table 1 below was prepared:

TABLE 1
Aqueous Pre-mix Formulation

| Ingredient | Amount (w/v %) |
|---|---|
| Kasugamycin hydrochloride | 2.3% |
| hydrate | (equivalent to kasugamycin-2.1%) |
| Copper monoglycinate | 17.32% |
| | (equivalent to copper-8.0%) |
| Surfactant: | 6.12% |
| Alkylphenylether + Ethylene glycol | |
| Potassium sorbate | 0.077% |
| Acid Blue No. 9 (coloring | 0.015% |
| agent) | |
| HCl (3N) | qs to adjust pH of formulation |
| | to about 3 |
| Water | qs |

### Example 2: Process of Preparation

1000 litres of aqueous pre-mix formulation was prepared with the composition shown in Table 1 above. For preparation of the formulation, about 500 litres of water was taken in a mixing tank and kasugamycin hydrochloride hydrate was added thereto with stirring until the kasugamycin hydrochloride hydrate was completely dissolved. Surfactant, potassium sorbate and coloring agent were added to the aqueous solution of kasugamycin hydrochloride hydrate. Copper monoglycinate was then added along with the balance amount of water (about 500 litres). The pH of the formulation was adjusted to about 3. The formulation was then filtered and filled in bottles.

Efficacy Studies

### Example 3: Foliar Application of Kasugamycin and Copper Glycinate in Tomato Plants (Var. Pony Express) for Controlling Xanthomonas campestris pv. vesicatoria

Tomato plants (var. Pony express) were foliar sprayed with formulations having kasugamycin alone, copper monoglycinate alone, and combination of kasugamycin and copper monoglycinate. The formulation having kasugamycin alone was applied at a dosage of 2.1 g/kg of kasugamycin (2.3 g/kg of kasugamycin hydrochloride hydrate) and the treatment was designated as T₁. The formulation having copper monoglycinate was applied at a dosage of 8 g/kg of copper (17.32 g/kg of copper monoglycinate) and the treatment was designated as T₂. The formulation having kasugamycin and copper monoglycinate was applied at a dosage of 2.1 g/kg of kasugamycin (2.3 g/kg of kasugamycin hydrochloride hydrate) and 8 g/kg of copper (17.32 g/kg of copper monoglycinate) and the treatment was designated as T₃.

Three applications were made every 7 days when the first symptoms of the disease appeared, and the % control of Pseudomonas syringae was determined. Control percentage of Xanthomonas campestris pv. vesicatoria with the K+CuGly mixture, as well as of kasugamycin and copper glycinate separately are provided in Table 2 below:

TABLE 2
Control percentage of Xanthomonas campestris pv. vesicatoria
in tomato plants (var. Pony express)

| No. | Treatment | % control |
|---|---|---|
| T₁ | Kasugamycin alone | 93.2% |
| T₂ | Copper glycinate alone | 80.5% |
| T₃ | Kasugamycin + copper glycinate | 97.5% |

### Example 4: Foliar Application of Kasugamycin and Copper Glycinate in Apple Trees (var. gala) for Controlling Erwinia amylovora

Apple trees (var. gala) were foliar sprayed with formulations having kasugamycin alone, copper glycinate alone, and combination of kasugamycin and copper glycinate. The formulation having Kasugamycin alone was applied at a dosage of 3.15 g/kg of kasugamycin (3.45 g/kg of kasugamycin hydrochloride hydrate). The formulation having copper monoglycinate was applied at a dosage of 8 g/kg of copper (17.32 g/kg of copper monoglycinate). The formulation having kasugamycin and copper monoglycinate was applied at a dosage of 3.15 g/kg of kasugamycin (3.45 g/kg of kasugamycin hydrochloride hydrate) and 8 g/kg of copper (17.32 g/kg of copper monoglycinate).

Three applications were made every 7 days when the first symptoms of the disease appeared, and the % control of Erwinia amylovora was determined. Control percentage of Erwinia amylovora with the K+CuGly mixture, as well as of kasugamycin and copper monoglycinate separately, are provided in Table 3 below:

TABLE 3
Control percentage of Erwinia amylovora in apple plants (var. Gala)

| No. | Treatment | % control |
|---|---|---|
| T₁ | Kasugamycin alone | 55.6% |
| T₂ | Copper monoglycinate alone | 50% |
| T₃ | Kasugamycin + copper | 83.3% |
| | glycinate | |

In Vitro Control of Fusarium spp Using Kasugamycin and Copper Glycinate

A strain of Fusarium spp isolated from potato was cultivated was in solid potato dextrose agar medium. The efficacy of the mixture of kasugamycin and copper glycinate in a 1:1 ratio, and each component individually was tested.

TABLE 4
Treatments

| Treatment | Product | Dose L/400 L water |
|---|---|---|
| T₁ | Kasugamycin | 1 |
| T₂ | Copper glycinate | 1 |
| T₃ | Kasugamycin + | 1 |
| | copper glycinate | |

The in vitro assessment of the products effectiveness was carried out as per the treatments discussed in Table 4. Accordingly, the components in each treatment were dissolved in PDA culture medium at the dose indicated above. The mixture was homogenized and poured into sterile petri dishes. Explants of 5 mm diameter of the fungus strain Fusarium spp. were placed on the petri dishes with PDA. The dishes were incubated inverted, in dark conditions at a temperature of 28-30° C. The evaluation of the inhibition of the fungus was carried out 7 days later. Control percentage of Fusarium sp. with the K+CuGly mixture, as well as of kasugamycin and copper monoglycinate separately are provided in Table 5 below:

TABLE 5
Control percentage of Fusarium sp.

| No. | Treatment | % control |
|---|---|---|
| T₁ | Kasugamycin alone | 55% |
| T₂ | Copper glycinate alone | 39% |
| T₃ | Kasugamycin + copper | 79% |
| | glycinate | |

In Vitro Control of Alternaria alternata Using Kasugamycin and Copper Glycinate

Alternaria alternata was cultivated was in solid potato dextrose agar medium. The efficacy of the mixture of kasugamycin and copper glycinate in a 1:1 ratio, and each component individually was tested.

TABLE 6
Treatments

| Treatment | Product | Dose L/400 L water |
|---|---|---|
| T₁ | Kasugamycin | 1 |
| T₂ | Copper glycinate | 1 |
| T₃ | Kasugamycin + | 1 |
| | copper glycinate | |

The in vitro assessment of the products effectiveness was carried out as per the treatments discussed in Table 6. Accordingly, the components in each treatment were dissolved in PDA culture medium at the dose indicated above. The mixture was homogenized and poured into sterile petri dishes. Explants of 5 mm diameter of the fungus strain Alternaria alternata were placed on the petri dishes with PDA. The dishes were incubated inverted, in dark conditions at a temperature of 28-30° C. The evaluation of the inhibition of the fungus was carried out 7 days later. Control percentage of Alternaria alternata with the K+CuGly mixture, as well as of kasugamycin and copper monoglycinate separately are provided in Table 5 below:

TABLE 7
Control percentage of Alternaria alternata

| No. | Treatment | % Control |
|---|---|---|
| T₁ | Kasugamycin alone | 79% |
| T₂ | Copper glycinate alone | 53% |
| T₃ | Kasugamycin + copper | 100% |
| | glycinate | |

Based on the aforesaid studies, it could be concluded that the compositions including kasugamycin or salt thereof and a copper salt exhibits wide spectrum of synergistic antibacterial and antifungal activities.

### Advantages

The present disclosure provides a new and improved synergistic agricultural composition that may overcome the limitations associated with the conventional agricultural compositions.

The present disclosure provides a synergistic agricultural composition that exhibits broad spectrum antifungal and antibacterial activity.

The present disclosure provides a synergistic agricultural composition that exhibits desired antifungal and antibacterial effect at lower dosage.

The present disclosure provides a synergistic agricultural composition that is easy to prepare.

The present disclosure provides a synergistic agricultural composition that is cost-effective.

The present disclosure provides a synergistic agricultural composition that is safe to use.

1. A combination comprising kasugamycin or a salt thereof, and a copper salt.

2. The combination as claimed in claim 1, wherein the copper salt is copper glycinate.

3. The combination as claimed in claim 1, wherein the weight ratio of kasugamycin or a salt thereof and copper salt is from 1:1 to 1:30.

4. The combination as claimed in claim 3, wherein the weight ratio of kasugamycin or a salt thereof and copper salt is from 1:1 to 1:10.

5. An agricultural composition comprising kasugamycin or a salt thereof, and a copper salt; wherein the weight ratio of kasugamycin or a salt thereof and the copper salt is from 1:1 to 1:30.

6. The composition as claimed in claim 5, wherein weight ratio of kasugamycin or a salt thereof and copper salt is from 1:1 to 1:10.

7. The composition as claimed in claim 5, wherein the copper salt comprises copper glycinate, copper monoglycinate, copper diglycinate, copper hydroxide, copper sulphate, tribasic copper sulphate, copper oxychloride, copper nitrate, copper chloride, or a combination thereof.

8. The composition as claimed in claim 5, wherein the kasugamycin salt is kasugamycin hydrochloride hydrate.

9. The composition as claimed in claim 5, wherein the composition is a liquid composition.

10. The composition as claimed in claim 5, wherein the composition further comprises an agricultural acceptable excipient.

11. The composition as claimed in claim 5, wherein the composition further comprises an herbicide, a fungicide, an insecticide or an acaricide.

12. The agricultural composition as claimed in claim 10, wherein the agricultural acceptable excipient is a surfactant comprising an alkyl phenyl ether and a polyol.

13. The composition as claimed in claim 12, wherein the polyol comprises ethylene glycol, propylene glycol, butylene glycol, diethylene glycol, triethylene glycol, dipropylene glycol, glycerol, trimethylolpropane, or a combination thereof.

14. The composition as claimed in claim 12, wherein the agricultural acceptable excipient is a surfactant comprising an alkyl phenyl ether and ethylene glycol.

15. The composition as claimed in claim 5, wherein said composition comprises kasugamycin in an amount from about 1% w/v to about 20% w/v of the composition.

16. The composition as claimed in claim 5, wherein said composition comprises the copper salt in an amount from about 10% w/v to about 40% w/v of the composition.

17. A liquid agricultural composition comprising
(i) kasugamycin or a salt thereof,
(ii) a copper salt, and
(iii) an agriculturally acceptable excipient; wherein the weight ratio of kasugamycin or the salt thereof and the copper salt is from 1:1 to 1:30.

18. The composition as claimed in claim 17, wherein said composition is an aqueous composition.

19. The composition as claimed in claim 17, wherein the weight ratio of kasugamycin or a salt thereof and the copper salt is from 1:1 to 1:10.

20. The composition as claimed in claim 17, wherein the copper salt is copper glycinate.

21. A method of controlling phytopathogens comprising applying at the locus of the infection by the phytopathogen or to a plant or to a plant part or to a plant propagation material the composition of claim 5.

22. The method as claimed in claim 21, wherein the copper salt is copper glycinate.

23. The method as claimed in claim 21, wherein the kasugamycin or a salt thereof is applied at a dosage from 1 to 10 g/kg of kasugamycin and the copper glycinate is applied at a dosage from 5 to 20 g/kg of copper.

24. (canceled)

25. (canceled)
